(19) United States
(12) Patent Application Publication
(10) Pub. No.: US 2009/0147274 A1
(43) Pub. Date: Jun. 11, 2009

(54) Document generation method, document generation system, and printing system

(75) Inventors: Shoji Kojima, Chino-Shi (JP); Yuki Nishida, Tokyo-to (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/901,879

(22) Filed: Sep. 19, 2007

(30) Foreign Application Priority Data
Sep. 19, 2006 (JP) 2006-252776
Sep. 18, 2007 (JP) 2007-240514

(51) Int. Cl. G06K 15/02

(52) U.S. Cl. 358/1.2

(57) ABSTRACT

[Object] To control a protrusion amount which indicates an amount of protrusion of an image protruding to a surrounding portion of a sheet for printing when marginless printing is performed in accordance with the XHTML-print specification.

[Solving Means] The UI processor 11 accepts designation of a size of a sheet for printing and designation of an amount of protrusion from the sheet for printing when marginless printing is performed. The XHTML document generation unit 12 generates an XHTML document including a size of an image to be printed which is specified in accordance with a scale factor used when marginless printing is performed in accordance with the XHTML-print specification, a print starting position of the image to be printed which is specified in accordance with the scale factor and the specified amount of protrusion, and designation of marginless printing.

### BACKGROUND OF THE INVENTION

1. Field of the Invention

The present invention relates to techniques of controlling an amount of protrusion of an image to be printed to a surrounding portion of a sheet for printing when marginless printing is performed. Particularly, the present invention relates to a technique of controlling an amount of protrusion of an image to be printed when marginless printing is performed in accordance with the XHTML-print specification.

2. Description of the Related Art

In general, when marginless printing is performed, a size of an image to be printed is not the same as a sheet size, the image is enlarged by a predetermined scale factor so that the size of the image becomes slightly larger than the sheet size, and the enlarged image is printed in a range larger than the sheet, that is, the enlarged image is printed so as to slightly protrude from the sheet (refer to Patent Document 1, for example). With this technique, even when the sheet skews a little while being fed, margins are not generated.

Patent Document 1: Japanese Unexamined Patent Application Publication No. 2004-297781

Patent Document 2: U.S. Patent Published Application No. 2005/0225779

The XHTML-print specification has been used. When a printing operation is performed in accordance with the XHTML-print specification and margins which indicate the widths of a frame are set to “0 mm”, marginless printing is performed. In this case also, an image is printed so that the image is slightly protruded from a sheet as described above.

However, in a case where the XHTML-print specification is employed, although it is determined that marginless printing is instructed when the margin is set to “0 mm”, since an image is enlarged in a fixed scale factor, a protrusion amount, which is an amount of protrusion of the image to a surrounding portion of a sheet for printing, is not controlled. When the protrusion amount is large, marginless printing is reliably attained. However, a portion of the image which is protruded is not printed. Therefore, if a portion of the image corresponding to a subject a user wishes to print is located in an edge portion of the entire image, the portion of the image corresponding to the subject may be cut out. Furthermore, the user may wish to enlarge a center portion of the image corresponding to a particular subject in order to print the center portion of the image by cutting out other portions of the image surrounding the center portion. In this case, there is a disadvantage in that, although a protrusion amount should be controlled, when the XHTML-print specification is employed, the protrusion amount is not controlled at a time of marginless printing.

Accordingly, if the user can control a protrusion amount, the user can determine whether a portion of an image which is located in an edge portion of the image is printed, which is preferable.

Accordingly, an object of the invention is to control an amount of protrusion of an image to a surrounding portion of a sheet for printing when marginless printing is performed in accordance with the XHTML-print specification.

### SUMMARY OF THE INVENTION

Accordingly, it is an object of the present invention to provide a method for generating a document in accordance with a print specification in which marginless printing is set by setting margins indicating widths of a frame to 0, the method including the steps of

accepting designation of a size of a sheet for printing, an amount of protrusion from the sheet for printing at a time of the marginless printing,

obtaining a scale factor used when the marginless printing is performed in accordance with the print specification, and specifying a size of an image to be printed on the basis of the designated size of the sheet for printing, the designated amount of protrusion, and the scale factor,

specifying a printing start position on the sheet for printing on which the image having the specified size is printed, and

generating a document including designations of the specified size of the image and the specified printing start position and further including designation of the marginless printing.

Other features of the invention will become apparent from description of the specification and the accompanying drawings.

### BRIEF DESCRIPTION OF THE DRAWINGS

FIG. 1 shows a block diagram illustrating a configuration of a printing system 1 according to an embodiment of the present invention.

FIG. 2 shows an example of a screen for setting of marginless printing.

FIG. 3 shows an example of a sheet data table.

FIG. 4 shows an example of a protrusion amount conversion table.

FIG. 5 shows a diagram used to illustrate items of the data table and the protrusion amount conversion table.

FIG. 6 shows a diagram illustrating an image frame.

FIG. 7 shows a flowchart illustrating a processing procedure of this system.

FIG. 8 shows a diagram illustrating a generated XHTML document (when a protrusion amount is set to “small”).

FIG. 9 shows a diagram illustrating a generated XHTML document (when a protrusion amount is set to “large”).

FIG. 10 includes a diagram illustrating an image frame when the protrusion amount is set to “small” and a diagram illustrating an image frame when the protrusion amount is set to “large”.

### REFERENCE NUMERALS

1: printing system, 2: printing engine, 5: sheet data table, 6: protrusion amount conversion table, 11: UI processor, 12: XHTML document generation unit, 13: sheet data management unit, 14: XHTML processor, 100: printing setting screen

### DETAILED DESCRIPTION OF THE PREFERRED EMBODIMENTS

According to this specification and the accompanying drawings, at least the following points will become apparent.

There is provided a method for generating a document in accordance with a print specification in which marginless printing is set by setting margins indicating widths of a frame to 0, the method including the steps of

accepting designation of a size of a sheet for printing, an amount of protrusion from the sheet for printing at a time of the marginless printing,

obtaining a scale factor used when the marginless printing is performed in accordance with the print specification, and specifying a size of an image to be printed on the basis of the designated size of the sheet for printing, the designated amount of protrusion, and the scale factor,

specifying a printing start position on the sheet for printing on which the image having the specified size is printed, and

generating a document including designations of the specified size of the image and the specified printing start position and further including designation of the marginless printing.

Accordingly, in the marginless printing in accordance with the print specification performed by setting the margins indicating widths of a frame to 0, the user can control the amount of protrusion.

The method may further include the step of obtaining the document including the designation of the marginless printing and image data corresponding to the image to be printed, enlarging the image to be printed using the scale factor, arranging the image to be printed on the basis of the document including the designation of the marginless printing, and generating printing data of the image after arranging the image.

The step of specifying the size of the image to be printed may further include the steps of specifying an image frame so that the specified amount of protrusion is obtained relative to the sheet for printing having the specified size at a time of enlargement by the scale factor, and specifying a size of the image to be printed by enlarging or reducing the image to be printed so that the image to be printed covers the image frame and a height or a width of the image to be printed coincides with a height or a width of the image frame so that the image to be printed fits the image frame.

Accordingly, even when a horizontal to vertical size ratio of the image to be printed does not coincide with a horizontal to vertical size ratio of the sheet for printing, the printing can be performed with the amount of protrusion specified by the user.

There is provided a computer program which is used to generate a document in accordance with a print specification in which marginless printing is set by setting margins indicating widths of a frame to 0. The computer program makes a computer execute the steps of

accepting designation of a size of a sheet for printing, an amount of protrusion from the sheet for printing at a time of the marginless printing,

obtaining a scale factor used when the marginless printing is performed in accordance with the print specification, and specifying a size of an image to be printed on the basis of the designated size of the sheet for printing, the designated amount of protrusion, and the scale factor,

specifying a printing start position on the sheet for printing on which the image having the specified size is printed, and

generating a document including designations of the specified size of the image and the specified printing start position and further including designation of the marginless printing.

Accordingly, in the marginless printing in accordance with the print specification performed by setting the margins indicating widths of a frame to 0, the user can control the amount of protrusion.

There is provided a system of generating a document in accordance with a print specification used for a setting of marginless printing by setting margins indicating widths of a frame to 0. The system includes

(A) an interface which accepts designation of a size of a sheet for printing, an amount of protrusion from the sheet for printing at a time of the marginless printing, and

(B) a document generation unit configured to

obtain a scale factor used when the marginless printing is performed in accordance with the print specification, and specify a size of an image to be printed on the basis of the designated size of the sheet for printing, the designated amount of protrusion, and the scale factor,

specify a printing start position on the sheet for printing on which the image having the specified size is printed, and

generate a document including designation of the specified size of the image and designation of the specified printing start position and further including designation of the marginless printing.

Accordingly, in the marginless printing in accordance with the print specification performed by setting the margins indicating widths of a frame to 0, the user can control the amount of protrusion.

There is provided a printing system that performs a printing operation using a document generated in accordance with a print specification used for a setting of marginless printing by setting margins indicating widths of a frame to 0. The printing system includes

(A) generation unit configured to

set a scale factor used when the marginless printing is performed,

obtain a document including designation of the marginless printing in which a size of an image to be printed is specified in accordance with an amount of protrusion from a sheet for printing at a time of performing the marginless printing and image data corresponding to the image to be printed, and

enlarge the image to be printed by the scale factor, arrange the image to be printed on the basis of the document, and generate printing data corresponding to the image after the image is arranged, and

(B) printing unit configured to print the printing data on the sheet for printing.

Accordingly, in the marginless printing in accordance with the print specification performed by setting the margins indicating widths of a frame to 0, the user can control the amount of protrusion.

A printing system according to an embodiment of the present invention will be described with reference the accompanying drawings.

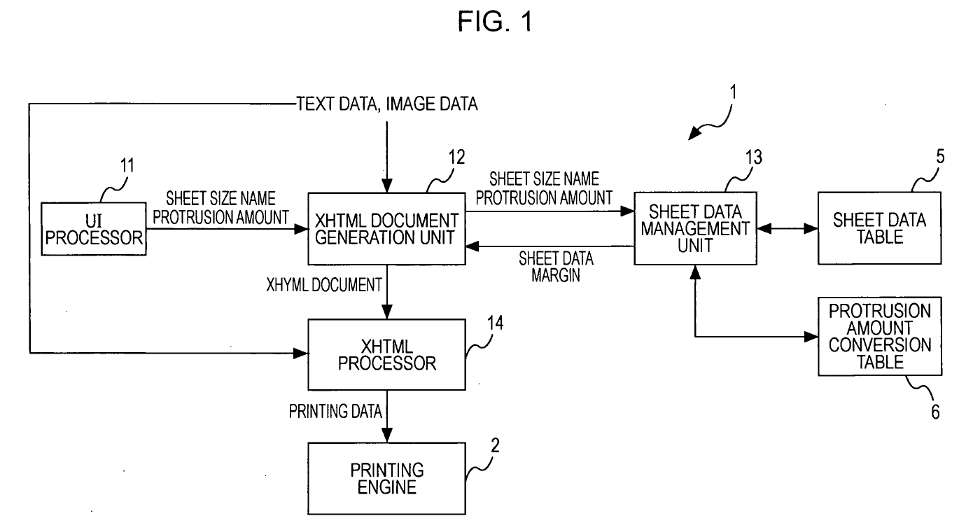

FIG. 1 shows a block diagram illustrating a configuration of a printing system 1 according to this embodiment.

The printing system 1 includes a UI processor 11 which provides a user interface, an XHTML document generation unit 12, a sheet data management unit 13, sheet data tables 5, protrusion amount conversion tables 6, an XHTML processor 14, and a printing engine 2 which executes a printing operation.

These components, except for the printing engine 2,. may be realized using a general computer system by executing a predetermined computer program or may be realized using a hardware circuit such as an ASIC (Application Specific Integrated Circuit). Alternatively, these components are realized using a combination of a computer program and a hardware circuit.

The UI processor 11 controls a display apparatus, not shown, to display a predetermined input screen so as to allow an input by a user. For example, when marginless printing is performed, the UI processor 11 controls display of a screen which accepts setting of a sheet size and a protrusion amount which is an amount of protrusion of an image to a surrounding portion of the sheet for printing. The UI processor 11 notifies the XHTML document generation unit 12 of the sheet size and the protrusion amount set by the user.

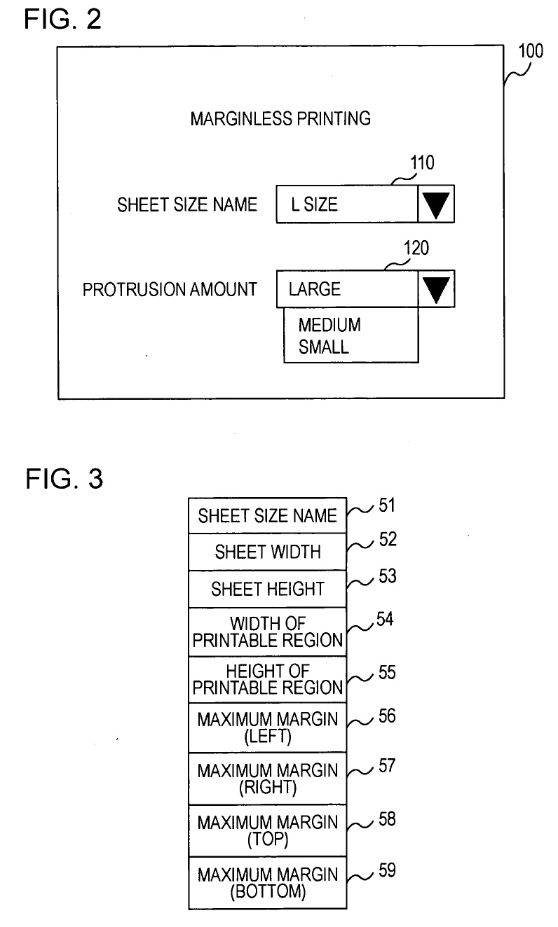

FIG. 2 shows an example of a marginless printing setting screen 100.

As shown in FIG. 2, the marginless printing setting screen 100 includes a sheet size input region 110 for inputting a sheet size and a protrusion amount input region 120. The sheet size input region 110 accepts a selection of a sheet size among sheet sizes, such as an L size, a 2L size, and an A4 size, provided in advance, the selection being performed by the user. The protrusion amount input region 120 accepts a selection of a degree of a protrusion amount among degrees of protrusion amounts provided in advance, the selection being performed by the user. In this embodiment, for example, there are three different degrees of protrusion amounts, i.e., “large”, “medium”, and “small”.

Referring back to FIG. 1, the sheet data tables 5 are provided for individual sheet sizes and each of the sheet data tables 5 stores therein data representing a physical paper size and data representing a range of printing of an image in marginless printing.

Each of the protrusion amount conversion tables 6 is used to convert one of the degrees of protrusion amounts, that is, “large”, “medium”, and “small” selected by the user into a corresponding length of an image which is actually printed in the surrounding portion of the sheet.

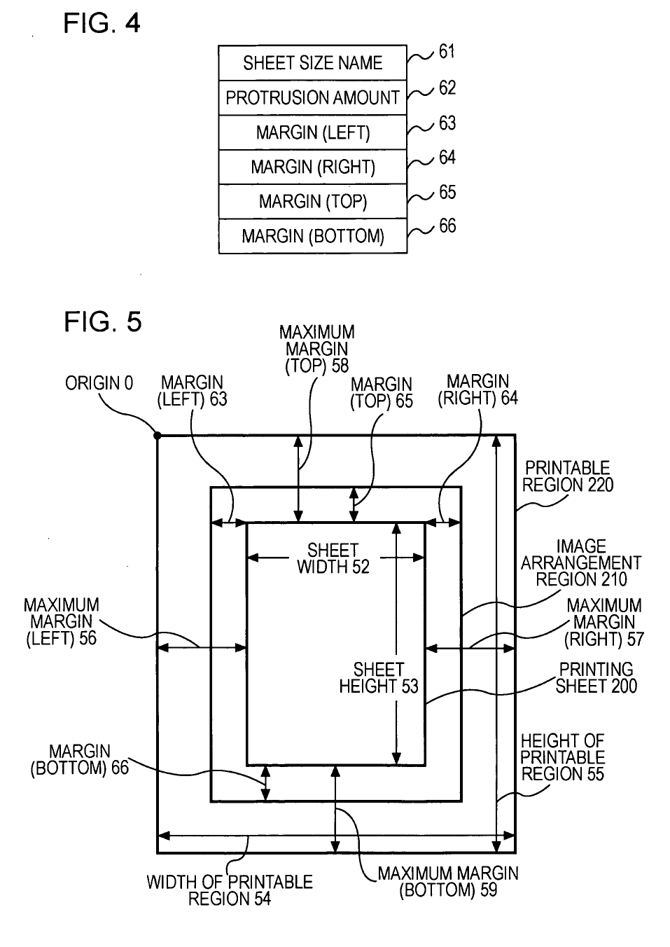

FIG. 3 shows an example of one of the sheet data tables 5 having data items, FIG. 4 shows an example of one of the protrusion amount conversion tables 6 having data items, and FIG. 5 shows a diagram used to illustrate the data items of one of the data tables and one of the protrusion amount conversion tables.

Referring to FIGS. 3 and 5, each of the sheet data tables 5 includes, as the data items, a sheet size 51, a sheet width 52, a sheet height 53, a width of a printable region 54, a height of a printable region 55, a maximum margin (left) 56, a maximum margin (right) 57, a maximum margin (top) 58, and a maximum margin (bottom) 59. As is apparent from these data items, each of the sheet data tables 5 provided for a corresponding sheet size 51 defines a physical size of a sheet corresponding to the sheet size 51 and a printable region when printing is performed on individual sheets.

The sheet width 52 and the sheet height 53 define a size of a sheet 200 for printing.

The width of a printable region 54 and the height of a printable region 55 define a printable region 220 for the sheet 200 for printing.

The maximum margin (left) 56, the maximum margin (right) 57, the maximum margin (top) 58, and the maximum margin (bottom) 59 are maximum values in which protrusions of the image can be printed and are located in left, right, top, and bottom portions surrounding the sheet 200 for printing, respectively. Accordingly, the printable region 220, which is a maximum sized printing region when the marginless printing is performed, has a width obtained by adding the maximum margin (left) 56 and the maximum margin (right) 57 to the sheet width 52 of the sheet 200 for printing and has a height obtained by adding the maximum margin (top) 58 and the maximum margin (bottom) 59 to the sheet height 53 of the sheet 200 for printing.

Referring to FIGS. 4 and 5, each of the protrusion amount conversion tables 6 includes, as data items, a sheet size 61, a protrusion amount 62, a margin (left) 63, a margin (right) 64, a margin (top) 65, and a margin (bottom) 66.

The margin (left) 63, the margin (right) 64, the margin (top) 65, and the margin (bottom) 66 are not maximum margins and allow protrusions of the image to be printed and are located in the left, right, top, and bottom portions surrounding the sheet 200 for printing, respectively. Accordingly, an image arrangement region 210 having a width obtained by adding the margin (left) 63 and the margin (right) 64 to the sheet width 52 of the sheet 200 for printing and a height obtained by adding the margin (top) 65 and the margin (bottom) 66 to the sheet height 53 of the sheet 200 for printing is defined as a region in which printing data generated in printing is actually arranged.

Note that a maximum margin means a margin designed so that marginless printing is successfully performed without generating margins even when the sheet skews due to a sheet feeding error. However, even when a margin is smaller than a maximum margin, the marginless printing may be successfully performed. Accordingly, the margin may be set so as to be smaller than the maximum margin.

In this embodiment, the margin (left) 63, the margin (right) 64, the margin (top) 65, and the margin (bottom) 66 are changed in accordance with a protrusion amount set by the user using the screen 100 whereby the user controls regions of the image (that is, regions corresponding to the margins) which are not printed.

As is apparent from the description above, the protrusion amount conversion tables 6 are provided for a corresponding sheet size 61 and a corresponding protrusion amount 62, and each of the protrusion amount conversion tables 6 defines margins of the left, right, top, and bottom portions protruding out of the sheet in detail, the portions allowing protrusion of the image to be printed. For example, when the user sets the sheet size to “2L size” and the protrusion amount to “small”, protrusion amounts of the left, right, top and bottom portions are determined in accordance with the margin (left) 63, the margin (right) 64, the margin (top) 65, and the margin (bottom) 66 which correspond to the sheet size 61 of “2L size” and the protrusion amount 62 of “small”.

Referring back to FIG. 1 again, the sheet data management unit 13 obtains sheet data corresponding to a sheet size set by the user from a corresponding one of the sheet data tables 5. Furthermore, the sheet data management unit 13 obtains the margin (left) 63, the margin (right) 64, the margin (top) 65, and the margin (bottom) 66 corresponding to the sheet size and a protrusion amount set by the user from a corresponding one of the protrusion amount conversion tables 6.

The XHTML document generation unit 12 obtains text data and image data to be printed and generates an XHTML document serving as a template used to arrange text corresponding to the text data and an image corresponding to the image data. The generated XHTML document is transmitted to the XHTML processor 14, and the XHTML processor 14 examines XHTML codes and synthesizes the image to be printed.

For example, when obtaining the sheet size and the protrusion amount specified by the user from the UI processor 11, the XHTML document generation unit 12 generates an XHTML document so that the printing engine 2 performs a printing operation on a sheet having a size corresponding to the selected sheet size in accordance with the selected protrusion amount. Steps of generating an XHTML document will be described hereinafter.

First, the XHTML document generation unit 12 notifies the sheet data management unit 13 of a sheet size and a protrusion amount obtained from the UI processor 11, and obtains sheet data representing a size of a sheet and margin data corresponding to the protrusion amount specified by the user from the sheet data management unit 13.

Note that, when the XHTML processor 14 processes an XHTML document to be subjected to the marginless printing, an image is enlarged with a predetermined scale factor and data for printing is generated using the enlarged image. The scale factor used here is determined in advance for each sheet size. Furthermore, the size of the image enlarged by the scale factor set for each sheet size corresponds to the printable region 220. Therefore, the XHTML document generation unit 12 calculates the scale factor used to enlarge the image using the XHTML processor 14 for performing the marginless printing.

The scale factors for sheet sizes are calculated using the following formulas obtaining a scale factor in a lateral direction and a scale factor in a longitudinal direction.

Scale Factor (Lateral Direction)=(Sheet Width+Maximum Margin (Left) +Maximum Margin (Right))/Sheet Width (1)

Scale Factor (Longitudinal Direction)=(Sheet Height+Maximum Margin (Top)+Maximum Margin (Bottom))/Sheet Height (2)

Here, the XHTML document generation unit 12 obtains the scale factor in the lateral direction and the scale factor in the longitudinal direction, and the smaller one of the scale factors is determined as the scale factor used for the sheet size. Alternatively, the image is not necessarily enlarged with one scale factor, but the image is enlarged by the scale factor in the lateral direction and the scale factor in the longitudinal direction, before the subsequent processing is performed. Moreover, since the scale factor is determined in advance for each sheet size, a numerical value of the scale factor may be stored in advance so that the numerical value does not need to be calculated every time the printing processing is performed. Alternatively, an identical scale factor may be associated with one or a plurality of sheet sizes.

Next, the XHTML document generation unit 12 determines an image frame in accordance with the margin determined in accordance with the protrusion amount specified by the user and the scale factor obtained by the above processing.

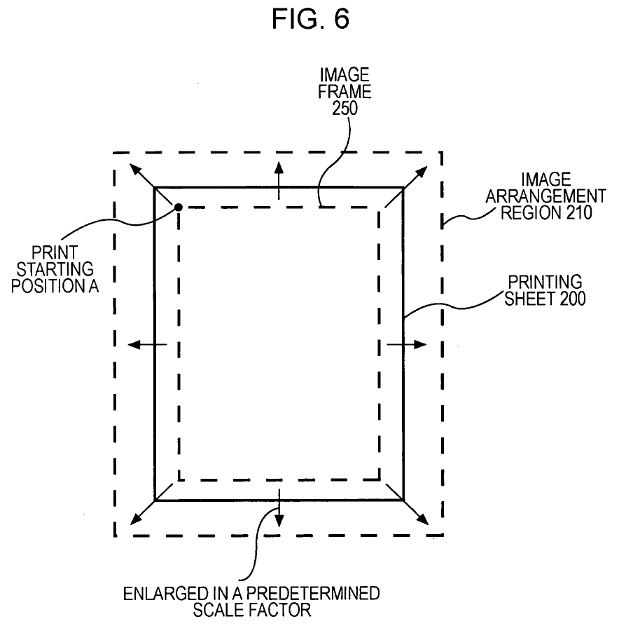

An image frame 250 will be described with reference to FIG. 6. The image frame 250 is a region of the image before being enlarged. The image corresponding to the image frame 250 is enlarged by the scale factor obtained as described above and is printed on the selected sheet 200 for printing in accordance with the selected protrusion amount (that is, is printed on the image arrangement region 210) in the marginless printing performed using the XHTML processor 14. The image frame is calculated using the following formulas.

Image Frame Width=(Sheet Width+Margin (Right)+Margin (Left))/Scale Factor (3)

Image Frame Height=(Sheet Height+Margin (Top)+Margin (Bottom))/Scale Factor (4)

The XHTML document generation unit 12 calculates an X-coordinate and a Y-coordinate of a printing start position A of the image using the following formulas. Note that, the coordinates of a point A located at an upper-left corner of the image frame shown in FIG. 6 serves as a parameter of a printing start position in the XHTML document. Therefore, the point A is referred to as the “printing start position” for convenience of illustration. However, the printing start position A is not an actual printing start position for the marginless printing. That is, the coordinates of the point A function as an indicator for arrangement of the image frame 250 on the sheet for printing.

X-Coordinate of Printing Start Position=(Maximum Margin (Left)−Margin (Left))/Scale Factor (5)

Y-Coordinate of Printing Start Position=(Maximum Margin (Top)−Margin (Top))/Scale Factor (6)

In a case where a horizontal to vertical size ratio of the original image to be printed does not coincide with a horizontal to vertical size ratio of the selected sheet 200 for printing, the size of the image is change by performing a fitting operation so that the image fits the sheet 200 for printing without generating a frame when the printing operation is performed.

The fitting operation is performed as follows, for example. The image is enlarged or reduced so that a pair of facing sides (top and bottom sides or left and right sides) of the image coincide with a corresponding pair of sides of the image frame 250 which is a rectangular region. Meanwhile, the other pair of facing sides of the image which do not coincide with a corresponding pair of facing sides of the rectangular region are located outside of the rectangular region. That is, the image frame 250 is entirely covered with the image to be printed, and furthermore, the image to be printed is enlarged or reduced so that the height or the width of the image to be printed coincides with the height or the width of the image frame 250. The fitting operation is thus performed. The width and the height of the image are determined by this fitting operation.

For example, when the width of the image is larger than the height thereof, the image is enlarged or reduced so that the top side and the bottom side of the image coincide with the top side and the bottom side of the image frame 250, respectively. That is, the image is enlarged or reduced so that the height of the image coincides with the height of the image frame. Since the printing operation is performed employing the fitting operation described above, even though part of the image may not be printed, margins are not generated in the sheet for printing.

On the basis of a result of the operation described above, the XHTML document generation unit 12 generates an XHTML document along with a name of an image file, and the XHTML document includes the following conditions.

(1) Marginless printing is specified (margins are set to 0 mm).
(2) The X and Y coordinates determined using formula (5) and formula (6) are specified as the printing start position A of the image.
(3) The width and the height of the image obtained after being subjected to the fitting operation are specified as the size of the image.

Furthermore, the XHTML document generation unit 12 adds information, that specifies a position where text is arranged, in the XHTML document.

The XHTML processor 14 is used to arrange the image and the text in accordance with the template specified by the XHTML document generated using the XHTML document generation unit 12 as described above, generate printing data, and make the printing engine 2 execute the printing operation. In this case, as repeatedly described above, when the marginless printing is specified, the XHTML processor 14 enlarges the image having a predetermined width and height with a predetermined scale factor.

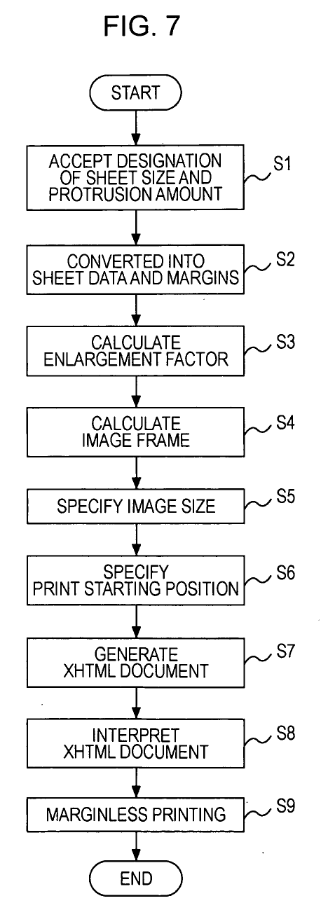

Next, processing steps of a system having the configuration described above will be described with reference to a flowchart shown in FIG. 7.

First, the UI processor 11 controls display of the marginless printing setting screen 100 and accepts a size of a sheet for printing and a protrusion amount input by the user (S11). The UI processor 11 notifies the XHTML document generation unit 12 of the input size of the sheet for printing and the protrusion amount.

The XHTML document generation unit 12 notifies the sheet data management unit 13 of the size of the sheet for printing and the protrusion amount, and the sheet data management unit 13 converts the size of the sheet for printing and the protrusion amount into sheet data and margins (S2).

The XHTML document generation unit 12 obtains the sheet data and the margins from the sheet data management unit 13 and calculates a scale factor for the specified size of the sheet (S3). Furthermore, the XHTML document generation unit 12 calculates an image frame in accordance with the scale factor and the margins (S4). The XHTML document generation unit 12 performs a fitting operation on the image to be printed so that the image fits the image frame to thereby determine a size of the image and a printing start position (S5 and S6). On the basis of these steps, the XHTML document generation unit 12 generates an XHTML document as a template used in the printing operation (S7).

The XHTML processor 14 examines the XHTML document and arranges the image in accordance with the prescribed template to thereby generate printing data (S8).

The printing engine 2 performs the marginless printing in accordance with the printing data (S9).

A method for generating the XHTML document will be described in more detail with reference to the flowchart described above. It is assumed that maximum margins (for the top, bottom, left, and right portions of the sheet) are set to 3 mm. Furthermore, it is assumed that when the protrusion amount is set to “large”, the margins (for the left and top portions of the sheet) are set to 4 mm, when the protrusion amount is set to “medium”, the margins (for the left and top portions of the sheet) are set to 2.5 mm, and when the protrusion amount is set to “small”, the margins (for the left and top portions of the sheet) are set to 1 mm. A case where the printing operation is performed in a longitudinal direction of an L-size sheet and the protrusion amount is set to “small” will be described hereinafter.

When the sheet size is determined to be an L-size (S1), the sheet data management unit 13 determines a concrete size of the sheet to be 89 mm×127 mm (S2). When the protrusion amount is set to “small” (S1), the margins (for the left and top portions of the sheet) are determined to be 1 mm (S2).

Next, a scale factor is obtained (S3). The scale factor is obtained using formula (1) and formula (2) described above. The determined values are assigned to formula (1) and formula (2) as follows.

Scale Factor (Lateral Direction)=(89 mm+3 mm+3 mm)/89 mm≈1.067

Scale Factor (Longitudinal Direction)=(127 mm+3 mm+3 mm)/127 mm≈1.047

As described above, the smaller scale factor is employed. Accordingly, 1.047 is employed as a scale factor for the entire image.

Next, a width and a height of the image frame are obtained using formula (3) and formula (4) (S4). The determined values are assigned to formula (3) and formula (4) as follows.

Image Frame Width (89 mm+1 mm+1 mm)/1.047≈86.914 Mm

Image Frame Height=(127 mm+1 mm+1 mm)/1.047≈123.209 mm

Next, the printing start position is obtained using formula (5) and formula (6) (S5 and S6). The determined values are assigned to formula (5) and formula (6) and an X-coordinate and a Y-coordinate of the printing start position are obtained as follows.

X-Coordinate of Printing Start Position=(3 mm−1 mm)/1.047≈1.910

Y-Coordinate of Printing Start Position=(3 mm−1 mm)/1.047≈1.910

In this way, the X-coordinate and Y-coordinate of the printing start position and the width and height of the image frame are obtained, and an XHTML document including these values is generated (S7).

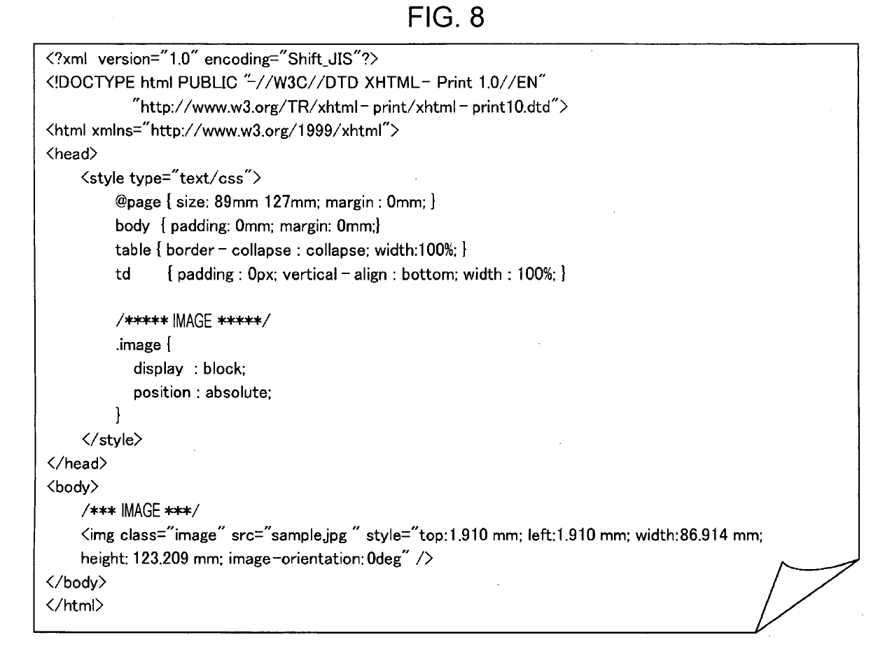

FIG. 8 is a diagram illustrating the generated XHTML document (when a protrusion amount is “small”). In FIG. 8, “size: 89 mm 127 mm” is described in a “<style>” section so that the sheet size is set. Furthermore, the size is followed by “margin: 0 mm” which indicates that the margins of the top, bottom, left, and right portions of the sheet are set to 0 mm. When these values are set, marginless printing is performed in accordance with the XHTML-printing specification.

As “style” included in a “<body>” section which is located in a latter part of the generated XHTML document, the values of the X-coordinate and the Y-coordinate of the printing start position, and the values of the width and the height of the image frame, which are obtained by calculations described above, are set. The value (1.910 mm) of the Y-coordinate of the printing start position is assigned to “top”, the value (1.910 mm) of the X-coordinate of the printing start position is assigned to “left”, the value (86.914 mm) of the width of the image frame is assigned to “width”, and the value (123.209 mm) of the height of the image frame is assigned to “height”. Note that “src” specifies the name of the image file, and “image-orientation: 0 deg” indicates that the image is not rotated.

The XHTML document thus generated is supplied to the XHTML processor 14. The XHTML processor 14 examines the XHTML document and generates printing data. The printing engine 2 performs the printing operation on the basis of the printing data (S9).

Since the XHTML document is generated as described above, in a case where the marginless printing is performed by setting “margin” to 0 mm, the image is arranged so as to be located in a center portion of the sheet, and thus the protrusion amount of the image can be controlled.

Note that the generated XHTML document includes the following items in addition to the items in script described above.

An item “body {padding: 0 mm; margin: 0 mm} indicates that offsets of top, bottom, left, and right portions of the sheet obtained by subtracting the margins of the sheet for printing from the sheet size are set to 0 mm and the top, bottom, left, and right margins of the printing region are also set to 0 mm. An item “table (border-collapse: collapse; width: 100%)” indicates that adjacent frames of a table of a style sheet overlap each other, and 100% of a width of the printing region is assigned to a width of the table.

An item “td{padding: 0 px; vertical-align: bottom; width: 100%;} indicates that offsets of top, bottom, left, and right portions of cells of the table are set to 0 mm and the cells are aligned with bottom lines of the cells in a vertical direction. In an “.image” section, an item “display: block;” indicates a rectangular mode as a display mode. Furthermore, an item “position: absolute;” indicates that a layout method employing an absolute display system is used as a layout display method.

Next, a method for generating an XHTML document in a case where the protrusion amount is set to “large” and the XHTML document is to be printed on an L-size sheet will be described.

First, the sheet size is determined to be an L-size and the protrusion amount is set to “large” (S1). When the sheet size is set to an L-size, the sheet data management unit 13 determines a concrete size of the sheet to be 89 mm×127 mm. When the protrusion amount is set to “large” (S1), the margins (for the left and top portions of the sheet) are determined to be 4 mm (S2).

Next, a scale factor is obtained (S3). The scale factor is obtained using formula (1) and formula (2) described above. The determined values are assigned to formula (1) and formula (2) as follows.

Scale Factor (Lateral Direction)=(89 mm+3 mm+3 mm)/89 mm≈1.067

Scale Factor (Longitudinal Direction)=(127 mm+3 mm+3 mm)/127 mm≈1.047

As described above, the smaller scale factor is employed. Accordingly, 1.047 is employed as a scale factor for the entire image.

Next, a width and a height of the image frame are obtained using formula (3) and formula (4) (S4). The determined values are assigned to formula (3) and formula (4) as follows.

Image Frame Width=(89 mm+4 mm+4 mm)/1.047≈92.645 mm

Image Frame Height=(127 mm+4 mm+4 mm)/1.047≈128.939 mm

Next, the printing start position is obtained using formula (5) and formula (6) (S5 and S6). The determined values are assigned to formula (5) and formula (6) and an X-coordinate and a Y-coordinate of the printing start position are obtained as follows.

X-Coordinate of Printing Start Position=(3 mm−4 mm)/1.047≈−0.955

Y-Coordinate of Printing Start Position=(3 mm−4 mm)/1.047≈−0.955

In this way, the X-coordinate and Y-coordinate of the printing start position and the width and height of the image frame are obtained, and an XHTML document including these values is generated (S7).

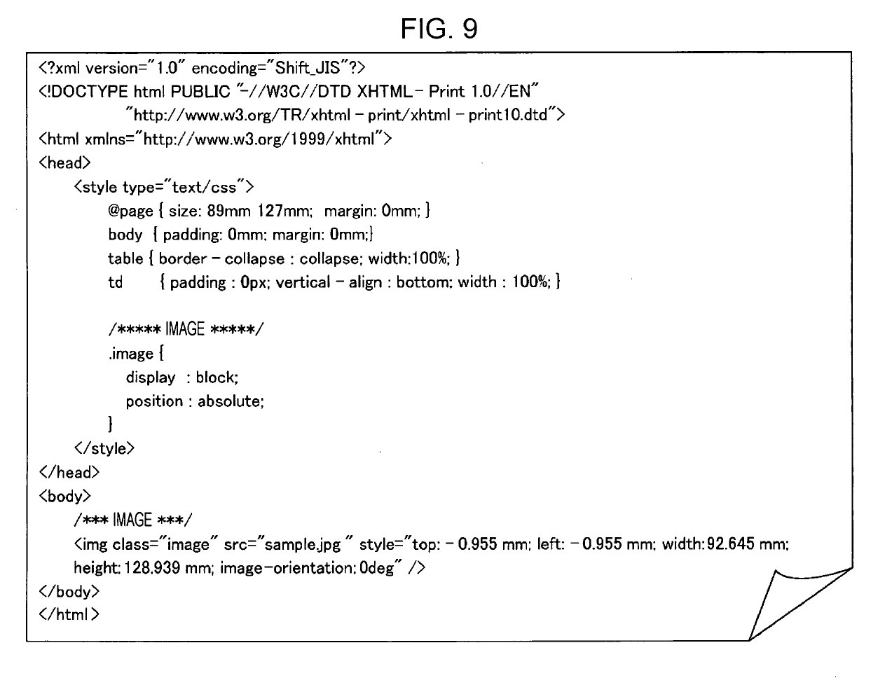

FIG. 9 is a diagram illustrating the generated XHTML document (when a protrusion amount is “small”). In FIG. 9, “size: 89 mm 127 mm” is described in a “<style>” section so that the sheet size is set. Furthermore, the size is followed by “margin: 0 mm” which indicates that the margins of the top, bottom, left, and right portions of the sheet is set to 0 mm.

As “style” included in a “<body>” section which is located in a latter part of the generated XHTML document, the values of the X-coordinate and the Y-coordinate of the printing start position, and the values of the width and height of the image frame, which are obtained by calculations described above, are set. The value (−0.955 mm) of the Y-coordinate of the printing start position is assigned to “top”, the value (−0.955 mm) of the X-coordinate of the printing start position is assigned to “left”, the value (92.645 mm) of the width of the image frame is assigned to “width”, and the value (128.939 mm) of the height of the image frame is assigned to “height”.

The XHTML document thus generated is supplied to the XHTML processor 14. The XHTML processor 14 examines the XHTML document and generates printing data. The printing engine 2 performs the printing operation on the basis of the printing data (S9).

As described above, the margins (4 mm) larger than the maximum margins (3 mm, herein) can be assigned by selecting the protrusion amount of “large”. Since the XHTML document is generated as described above, in a case where the marginless printing is performed by setting “margin” to 0 mm, the image is arranged so as to be located in the center portion of the sheet, and thus the protrusion amount of the image can be controlled.

Note that the descriptions are made for a case where the protrusion amount is set to “small” and a case where the protrusion amount is set to “large”. However, also in a case where the protrusion amount is set to “medium”, the same operation is performed using a corresponding protrusion amount.

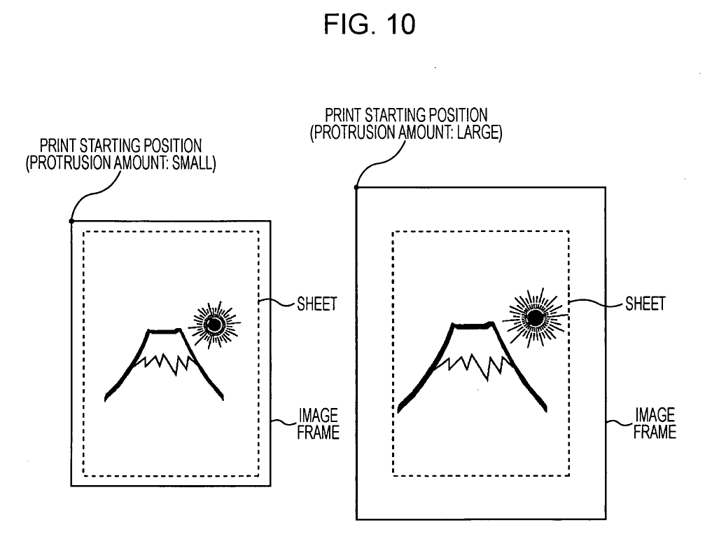

FIG. 10 includes a diagram illustrating an image frame when the protrusion amount is set to “small” and a diagram illustrating an image frame when the protrusion amount is set to “large”. In FIG. 10, an L-size sheet is represented by a dot line. An image frame obtained when the protrusion amount is set to “small” is represented by a solid line in a left diagram, whereas an image frame obtained when the protrusion amount is set to “large” is represented by a solid line in a right diagram.

As shown in FIG. 10, the image frame obtained when the protrusion amount is set to “large” is larger than the image frame obtained when the protrusion amount is set to “small” relative to the sheet. Since the image is printed so as to fit the image frame, the size of the image can be controlled by controlling the protrusion amount as shown in FIG. 10.

The embodiment of the invention described above is merely an example for explanation of the present invention, and the scope of the invention is not limited to the embodiment. Those who skilled in the art can realize the invention by employing various embodiments without departing from the scope of the invention.

For example, the present invention is applicable not only to the XHTML-print specification but also to any print specifications as long as a markup language (description language), such as an XML is used.

For example, the printing system of the embodiment described above may be accommodated in one case and realized as a printer. Alternatively, the printing system may be realized as a control apparatus including a printer having a printing engine, and other components, or a control apparatus including a printer having a printing engine and an XHTML processor, and other components.

Furthermore, the UI processor and the XHTML document generation unit may be mounted on a digital camera. Moreover, the sheet data management unit, the sheet data tables 5, the protrusion amount conversion tables 6, the XHTML processor 14, and the printing engine 2 may be included in a printing apparatus.

In this case, the digital camera transmits the sheet size and the protrusion amount through a USB interface, for example, to the sheet data management unit of a printer. Then, the sheet data management unit of the printer transmits corresponding sheet data and correspond margins to the digital camera.

In accordance with the pieces of data, the XHTML document is generated in the digital camera and the generated XHTML document is transmitted to the printer. The XHTML processor of the printer processes the document to generate printing data. By this, a printing operation in accordance with the printing data is performed.

The digital camera may include a cellular phone having a digital camera. In this case, the digital camera may be communicated with the printer using an infrared communication apparatus.

What is claimed is:

1. A method for generating a document in accordance with a print specification in which marginless printing is set by setting margins indicating widths of a frame to 0, the method comprising the steps of:
accepting designation of a size of a sheet for printing, an amount of protrusion from the sheet for printing at a time of the marginless printing;
obtaining a scale factor used when the marginless printing is performed in accordance with the print specification, and specifying a size of an image to be printed on the basis of the designated size of the sheet for printing, the designated amount of protrusion, and the scale factor;
specifying a printing start position on the sheet for printing on which the image having the specified size is printed; and
generating a document including designations of the specified size of the image and the specified printing start position and further including designation of the marginless printing.

2. The method for generating a document according to claim 1, the method further comprising the step of:
obtaining the document including the designation of the marginless printing and image data corresponding to the image to be printed, enlarging the image to be printed using the scale factor, arranging the image to be printed on the basis of the document including the designation of the marginless printing, and generating printing data of the image after arranging the image.

3. The method for generating a document according to claim 1,
wherein the step of specifying the size of the image to be printed further includes the steps of:
specifying an image frame so that the specified amount of protrusion is obtained relative to the sheet for printing having the specified size at a time of enlargement by the scale factor, and
specifying a size of the image to be printed by enlarging or reducing the image to be printed so that the image to be printed covers the image frame and a height or a width of the image to be printed coincides with a height or a width of the image frame so that the image to be printed fits the image frame.

4. A system of generating a document in accordance with a print specification used for a setting of marginless printing by setting margins indicating widths of a frame to 0, the system comprising:
(A) an interface which accepts designation of a size of a sheet for printing, an amount of protrusion from the sheet for printing at a time of the marginless printing; and
(B) a document generation unit configured to
obtain a scale factor used when the marginless printing is performed in accordance with the print specification, and specify a size of an image to be printed on the basis of the designated size of the sheet for printing, the designated amount of protrusion, and the scale factor,
specify a printing start position on the sheet for printing on which the image having the specified size is printed; and
generate a document including designation of the specified size of the image and designation of the specified printing start position and further including designation of the marginless printing.

5. A printing system that performs a printing operation using a document generated in accordance with a print specification used for a setting of marginless printing by setting margins indicating widths of a frame to 0, the printing system comprising:
(A) generation unit configured to
set a scale factor used when the marginless printing is performed,
obtain a document including designation of the marginless printing in which a size of an image to be printed is specified in accordance with an amount of protrusion from a sheet for printing at a time of performing the marginless printing and image data corresponding to the image to be printed, and
enlarge the image to be printed by the scale factor, arrange the image to be printed on the basis of the document, and generate printing data corresponding to the image after the image is arranged; and
(B) printing unit configured to print the printing data on the sheet for printing.
